(19) United States
(12) Patent Application Publication
(10) Pub. No.: US 2005/0148374 A1
(43) Pub. Date: Jul. 7, 2005

(54) Wireless earphone

(76) Inventor: Yen Hsi Lin, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/790,732

(22) Filed: Mar. 3, 2004

(30) Foreign Application Priority Data
Jan. 6, 2004 (TW) 93100275

(51) Int. Cl. H02J 7/24; H02J 7/06

(52) U.S. Cl. 455/575.2; 455/41.3

(57) ABSTRACT

A wireless earphone communicates with a mobile phone by wireless and comprises a microprocessor, a feedback-type charging circuit and a rechargeable battery therein. The microprocessor output control signals to control the feedback-type charging circuit for charging the rechargeable battery; the feedback-type charging circuit also feeds back the charging current and charging states of the rechargeable battery to the microprocessor. Therefore, the microprocessor may change the charging current depending on the states of the rechargeable battery. By changing the voltage of the control signals, the charging current of the feedback-type charging circuit can be adjusted by the microprocessor. The present invention provides a charging design by software control to reduce the production cost of wireless earphone.

### BACKGROUND OF THE INVENTION

1. Field of the Invention

The present invention is a wireless earphone, especially relates to a wireless earphone that can charge rechargeable batteries with an interior charging circuit.

2. Description of Related Art

Wireless earphones used with mobile telephones mainly use the Bluetooth™ wireless communication technique. Therefore, the above-mentioned earphone is also referred to a Bluetooth™ earphone. Rechargeable batteries are used as power sources for prior art Bluetooth™ earphones, and the rechargeable batteries are usually set inside the Bluetooth™ earphones. FIG. 1 shows a schematic structure diagram of the Bluetooth T earphone 70. A rechargeable battery 73 is charged by supplying a direct current to an input terminal of a charging IC 71, and the charging IC 71 will provide the electricity for the rechargeable battery 73. After the rechargeable battery 73 is charged, it will provide electric power for a Bluetooth T wireless communication circuit 75.

The structure shown in FIG. 1 uses a hardware which provides charging functions. A charging IC 73 (ex. TI BQ24010) is the above-mentioned hardware and integrates many other functions inside the earphone. The cost of using the charging IC 73 is more expensive than using simple charging circuit. Therefore, replacing charging IC 73 with simple charging circuit and using a control unit to control charging functions for charging circuit may reduce the production cost thereof.

### SUMMARY OF THE INVENTION

It is an object of the present invention to provide a cheaper wireless earphone.

Another object of the present invention is to provide a wireless earphone and adjust the charging current correctly by a feedback function. By this way, the voltage of the rechargeable battery is steadier.

Still another object of the present invention is to provide a wireless earphone and a buzzer for outputting a louder voice. Users will be warned of the operating states of the earphone.

To achieve above-mentioned objects, the present invention provides a wireless earphone connected wirelessly with a mobile phone. The wireless earphone comprises a communicating unit, a rechargeable battery, a charging circuit with feedback function, and a microprocessor. The communicating unit is used for receiving and emitting communication signals; the charging circuit provides current for charging the rechargeable battery and feedbacks states of the rechargeable battery; and the microprocessor controls the communication unit and outputs a control signal for adjusting the charging current of the charging circuit by identifying the states of the rechargeable battery.

To achieve above-mentioned objects, the present invention provides a charging circuit for receiving the control signals output from the microprocessor and charging a rechargeable battery. The charging circuit comprises: a charging current control circuit receiving input direct current and control signals, a first detecting circuit detecting the charging current of the charging current control circuit, and a second detecting circuit detecting the voltage value of the rechargeable battery. The charging current control circuit also outputs charging current and changes the current values according to the control signals. The microprocessor may detect the voltage value of the rechargeable battery by the second detecting circuit and the current value of the rechargeable battery by the first detecting circuit. Hence, the microprocessor can change the charging current and charge the rechargeable battery.

To achieve above-mentioned objects, the present invention provides a method for charging wireless earphones. A microprocessor, a feedback-type charging circuit and a charging circuit are set inside a wireless earphone, in which the microprocessor controls the feedback-type charging circuit for charging a rechargeable battery. The method for charging provides: detecting the voltage level of the rechargeable battery by the feedback-type charging circuit; comparing the difference between the voltage level of the rechargeable battery and its preset value; and adjusting the charging current of the feedback-type charging circuit by the microprocessor.

### BRIEF DESCRIPTION OF THE DRAWINGS

The various objects and advantages of the present invention will be more readily understood from the following detailed description when read in conjunction with the appended drawing, in which:

FIG. 1 shows a schematic diagram of a circuit structure inside a prior art wireless earphone;

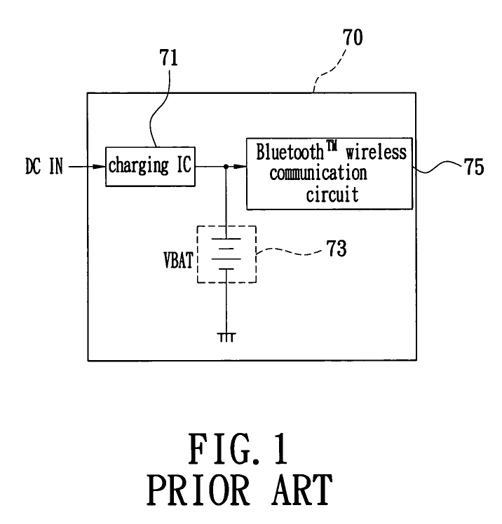

FIG. 2 shows a system block diagram of a preferred embodiment of the present invention;

FIG. 3 shows a diagram of a buzzer control circuit of the present invention;

FIG. 4 shows a feedback-type charging circuit diagram of a preferred embodiment of the present invention;

FIG. 5 shows a charging voltage wave diagram of a rechargeable battery in the present invention; and

FIG. 6 shows a state diagram of the rechargeable battery of the present invention.

### DETAILED DESCRIPTION OF PREFERRED EMBODIMENTS

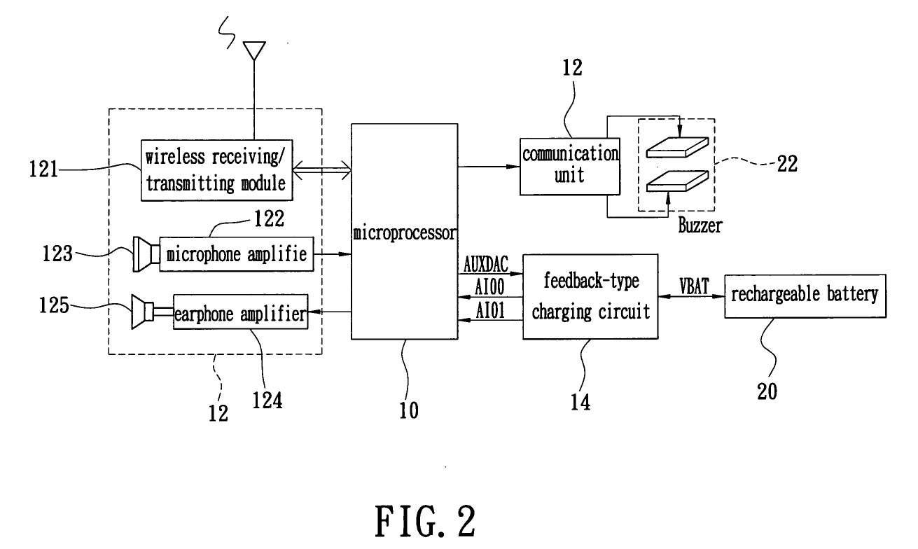

Reference is made to FIG. 2, which shows a system block diagram of the present invention. An internal structure of a wireless earphone in the present invention comprises a microprocessor 10, a communication unit 12, a feedback-type charging circuit 14, a rechargeable battery 20, a buzzer control circuit 16 and a buzzer 22.

The communication unit 12 can communicate with mobile phones by transferring wireless signals; the communication unit 12 has the same internal structure with prior art wireless earphones, which transfers wireless signals by a wireless receiving/transmitting module 121. Therefore, a microphone 123 can receive audio signals, and the audio signals will be processed by a microphone amplifier 122. After that, the wireless receiving/transmitting module will transmit the audio signals transferred by the microprocessor 10. The microprocessor 10 may also decode the wireless signals received by the wireless receiving/transmitting module 121 into audio signals; through an earphone amplifier 124, the audio signals are output by a speaker 125. Wireless receiving/transmitting module 121 is preferably a Bluetooth™ module.

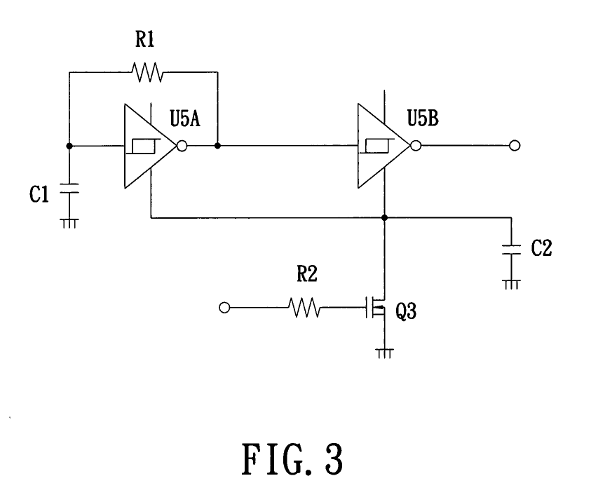

The present invention provides a buzzer control circuit 16, which controls the tone ring of the buzzer 22. Reference is made to FIG. 3, which shows a buzzer control circuit diagram. The microprocessor 10 outputs signals to the NMOS transistor Q3 via a resistor R2 for controlling on/off states of the NMOS transistor Q3, and output states of amplifiers (U5A and U5B) will be changed thus. Audio signals are output from amplifiers U5A and U5B and transmitted to two terminals of the buzzer 22. Hence, depending on the states (power on/off, dead battery or incoming call) of the wireless earphone, the microprocessor 10 can output different tone signals to drive the buzzer 22.

The present invention replaces prior art charging IC by the feedback-type charging circuit 14. The feedback-type charging circuit 14 is controlled by a control signals (AUXDAC) output from the microprocessor 10 and is used to feedback charging current and voltage states of the rechargeable battery to the microprocessor 10. If the voltage of the rechargeable battery 20 is abnormal, the microprocessor 10 will change the charging current. Further, the microprocessor 10 in this embodiment utilizes software control to change charging current and steady the voltages of the rechargeable battery 20 after charging is completed. The above-mentioned software control is related to change the voltage of the control signals (AUXDAC).

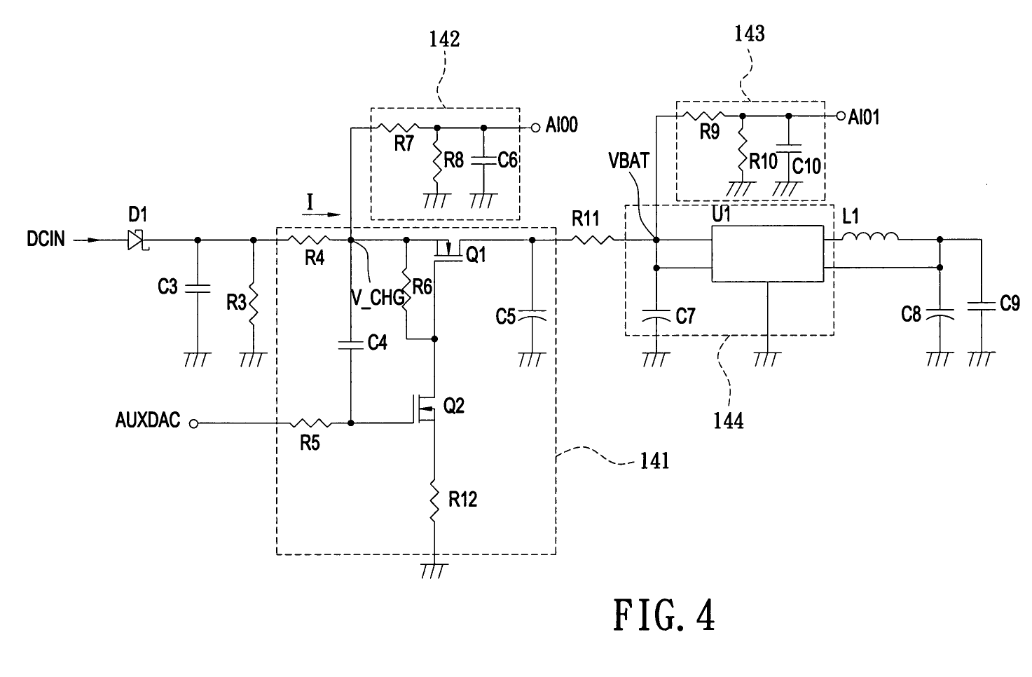

FIG. 4 depicts a charging circuit diagram of the feedback-type charging circuit in the present invention. The feedback-type charging circuit 14 comprises a charging current control circuit 141, a first detecting circuit 142, a second detecting circuit 143 and a voltage transforming circuit 144. An external direct current (DC IN) is input to the input terminals of the charging current control circuit 141 and the charging current control circuit 141 receives control signals (AUXDAC) output from the microprocessor 10 for controlling the charging current value (I).

The first detecting circuit 142 is connected to a connecting point V_CHG of the charging current control circuit 141 and the connecting point V_CHG feeds back a signal AI00 to the microprocessor 10 through a voltage divider network composed of resistors R7, R8. By identifying the voltage magnitude of the feedback signals AI00 and the following formula, charging current value I may be calculated.
V_{—}CHG=(DC IN)−I (charging current)*R4
AI00=V_{—}CHG*(R8)/(R7+R8)
where the resistor values and DC IN are already known. After the AI00 is detected by the first detecting value, V_CHG may be calculated first, and charging current value (I) will be obtained by using V_CHG value. It is concluded that AI00 and charging current (I) are related to each other.

The second detecting circuit 143 is connected to a connecting point VBAT of the charging current control circuit 141; the connecting point VBAT is connected to a rechargeable battery 20 (not shown) and it feeds back a signal AI01 to the microprocessor 10 through a voltage divider network composed of resistors R9, R10. By identifying the voltage magnitude of the feedback signals AI01, a voltage value of the rechargeable battery may be obtained by the microprocessor 10.

When the charging action is operated in the present invention, the second detecting circuit 143 will decide how much of the charging current is used according to the voltage of the rechargeable battery 20. The microprocessor 10 also can adjust the desired current value via changing the control signals (AUXDAC) after the first detecting circuit 142 detects the present current value. The charging current control circuit 141 mainly comprises a PMOS transistor, an NMOS transistor and other elements. Control signals AUXDAC is input into the gate of the NMOS transistor Q2 to control the drain current thereof. The voltage value of the resistor R6 is changed with the drain current of the NMOS transistor Q2. Thus, PMOS transistor Q1 changes the charging current value (I) with the variation of the voltage of the resistor R6.

The voltage transforming circuit 144 is connected to the output terminals of the charging current control circuit 141 and it transforms the voltage VBAT via a DC/DC transformer U1 into a voltage for the microprocessor 10 and the communicating unit 12.

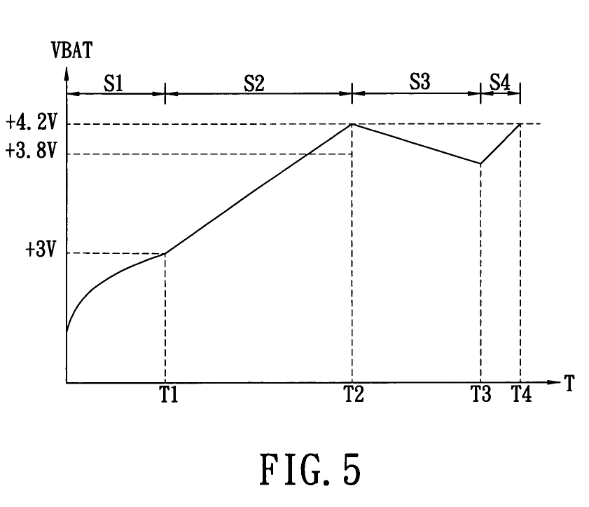

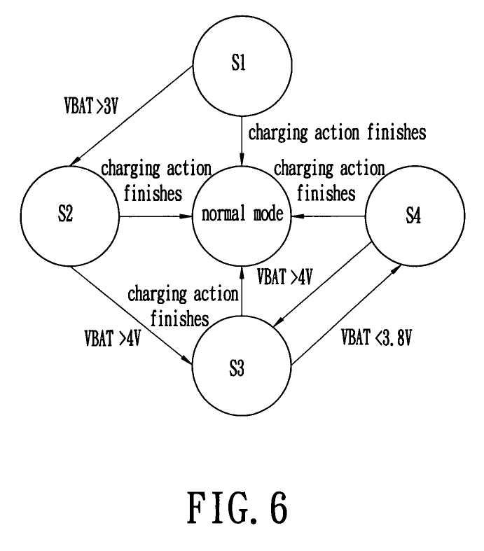

The present invention divides the charging procedure into several states. There are four stages S1, S2, S3, S4 shown in FIG. 5 and FIG. 6. The S1 state uses a 10 mA charging current when the voltage of the rechargeable battery 20 is smaller than 3V. The S2 state uses a 50 mA charging current when the voltage of the rechargeable battery 20 is larger than 3V but smaller than 4V. The S3 state uses a 0 mA charging current when the voltage of the rechargeable battery 20 is larger than 4V. Finally, the S4 state uses a 50 mA charging current when the voltage of the rechargeable battery 20 is smaller than 3.8V.

During the time period 0-T1, the voltage of the rechargeable battery 20 is smaller than 3V and charged as S1 state; during the time period T1-T2, the voltage of the rechargeable battery 20 is larger than 3V and charged as the S2 state. During the time period T2-T3, the voltage of the rechargeable battery 20 is larger than 4V and charged as the S3 state. During the time period T3-T4, the voltage of the rechargeable battery 20 is smaller than 3.8V and is charged as the S4 state. Finally, S3 and S4 state will be switched alternatively to maintain the voltage of the rechargeable battery 20 at nearly 4V. Additionally, unplugging the input power source (DC IN) plug will terminate the charging function and return to normal mode.

The present invention replaces prior art charging IC with feedback-type charging circuit 14 and includes software control provided by the microprocessor 10 for changing the charging current of the charging current control circuit 141. Integrating the feedback circuit of the first detecting circuit 142 and the second detecting circuit 143 can make more precise adjustments for the charging currents and the voltage of the rechargeable battery 20 is also kept in a stable range.

On another aspect, the present invention integrates a buzzer 22, and it is operated depending on the operation states, such as, for example, power on/off, incoming call or battery out of use, of the wireless earphone.

Therefore, the wireless earphone of the present invention includes following advantages:
1. reducing production costs;
2. providing a precise charging function by the design of feedback-type charging circuit; and
3. enlarging output voice of a speaker by a built-in buzzer and using different tones of the buzzer for different states of the wireless earphone.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A wireless earphone communicating with a mobile phone by wireless signals,
the wireless earphone comprising:
a communication unit receiving and emitting the wireless signals;
a rechargeable battery;
a feedback-type charging circuit providing a charging current for the rechargeable battery and feeding back charging states of the rechargeable battery; and
a microprocessor controlling operations of the communicating unit and outputting a control signal for adjusting the charging current of the feedback-type charging circuit.

2. The wireless earphone as in claim 1, wherein the communication unit comprises:
a microphone;
a speaker; and
a wireless receiving/transmitting module receiving signals from the microphone and transmitting signals wirelessly to a mobile phone, wherein wireless signals transmitted by the mobile phones are also received by the wireless receiving/transmitting module and output by the speaker.

3. The wireless earphone as in claim 1, wherein the wireless receiving/transmitting module is a Bluetooth™ module.

4. The wireless earphone as in claim 1, wherein the feedback-type charging circuit comprises:
a charging current control circuit receiving an input direct current and the control signals, wherein the charging current control circuit also outputs the charging current and changes the charging current value according to the control signals;
a first detecting circuit detecting the charging current of the charging current control circuit; and
a second detecting circuit detecting the voltage value of the rechargeable battery;
wherein the microprocessor detects the voltage value of the rechargeable battery by the second detecting circuit and the current value of the rechargeable battery by the first detecting circuit and the microprocessor hence changes the charging current and charges the rechargeable battery.

5. The wireless earphone as in claim 4, wherein the charging current control circuit comprises:
a first MOS transistor having a third terminal for outputting the charging current;
a second MOS transistor having a first terminal connected to a second terminal of the first MOS transistor, the control signals being input to a second terminal of the second MOS transistor;
a resistor having two terminals connected to the first terminal and the second terminal of the first MOS transistor, respectively; and
a capacitor having two terminals connected to the first terminal of the first MOS transistor and the second terminal of the second MOS transistor.

6. The wireless earphone as in claim 4, further comprising a voltage transforming circuit connected to the output terminal of the charging current control circuit.

7. The wireless earphone as in claim 1, further comprising a buzzer, wherein a tone of the buzzer is controlled by a buzzer control circuit connected between the microprocessor and the buzzer.

8. A charging circuit of a wireless earphone receiving control signals output from a microprocessor and charging a rechargeable battery, the charging circuit comprising:
a charging current control circuit receiving an input direct current and the control signals, wherein the charging current control circuit also outputs the charging current and changes a charging current value according to the control signals;
a first detecting circuit detecting the charging current of the charging current control circuit; and
a second detecting circuit detecting a voltage value of the rechargeable battery;
wherein the microprocessor detects the voltage value of the rechargeable battery by the second detecting circuit and the current value of the rechargeable battery by the first detecting circuit, and the microprocessor changes the charging current for charging the rechargeable battery.

9. The charging circuit of the wireless earphone as in claim 8, wherein the charging current control circuit comprises:
a first MOS transistor having a third terminal for outputting the charging current;
a second MOS transistor having a first terminal connected to a second terminal of the first MOS transistor, wherein the control signals are input into a second terminal of the second MOS transistor;
a resistor having two terminals connected to the first terminal and the second terminal of the first MOS transistor, respectively; and
a capacitor having two terminals connected to the first terminal of the first MOS transistor and the second terminal of the second MOS transistor.

10. The charging circuit of the wireless earphone as in claim 8, further comprising a voltage transforming circuit connected to the output terminal of the charging current control circuit.

11. A method for charging a wireless earphone, the wireless earphone having a microprocessor, a feedback-type charging circuit and a charging circuit set therein, wherein the microprocessor controls the feedback-type charging circuit to charge a rechargeable battery, the method having steps as follows:
detecting a voltage level of the rechargeable battery with the feedback-type charging circuit;
comparing a difference between the voltage level of the rechargeable battery and a preset value by the microprocessor; and
adjusting a charging current of the feedback-type charging circuit by the microprocessor.

12. The method for charging the wireless earphone as in claim 11, further comprising a step of detecting the charging current for the microprocessor by the feedback-type charging circuit.
